(19) United States
(12) Patent Application Publication
(10) Pub. No.: US 2012/0086642 A1
(43) Pub. Date: Apr. 12, 2012

(54) Keyboard for touchscreen

(75) Inventor: Orion Weihe, Fremont, CA (US)

(73) Assignee: Amarante Technologies, Inc., Santa Clara, CA (US)

(21) Appl. No.: 12/898,714

(22) Filed: Oct. 6, 2010

(51) Int. Cl. G06F 3/02

(52) U.S. Cl. 345/168

(57) ABSTRACT

Keyboard systems for interfacing with a touchscreen. The keyboard includes: a plurality of contact members formed of electrically conducting material, each of the contact members having first and second sides; and a plurality of keys. Each key has an electrically conducting key-pad unit and a resilient member, where the resilient member is adapted to maintain the key-pad unit in a spaced part relationship relative to a corresponding one of the contact members. The first side of each contact member is in constant contact with a particular portion of the touchscreen. The key-pad unit is adapted to contact the second side of a corresponding one of the contact members when pressed by a foreign object, to thereby form an electrically conducting path between the foreign object and the particular portion of the touchscreen.

### BACKGROUND OF THE INVENTION

The present invention relates to data entry keyboards, and more particularly, to tactile keyboards for touch screen.

With the advancement of electronic technologies, touchscreens have become increasingly popular in the field of consumer electronics. A touchscreen is a display capable of detecting the presence and location of a touch (or stimulus) within a display area and interpreting the touch as input. The ability of a touchscreen to receive (i.e., detect and interpret) a stimulus is typically enabled through the use of a plurality of touch-sensitive sensors embedded in the touchscreen.

Touch-sensitive sensors respond to a stimulus and produce a signal indicative of the stimulus's magnitude, relative position, or other characteristic attributable to the stimulus. Typical touch-sensitive sensor implementations in the field of consumer electronics include resistive sensing, capacitive sensing, infrared sensing, optical imaging and dispersive signal technology.

Applications in which touchscreen applications may be used include display interfaces of computing devices, such as notebook computers, iPad™ tablet computer, personal data assistants (PDAs), and mobile phones. Other popular applications in which touchscreens have been incorporated include the user interfaces of bank automated telling machines, kitchen appliances, exercise equipment, satellite navigation devices and various other consumer electronics.

Displays which offer touchscreen functionality provide substantial benefits over traditional displays. These benefits include the ability to directly interact with the content displayed on the touchscreen, rather than indirectly with a dedicated input device, such as a keyboard, keypad, mouse, or touchpad. Another benefit of a touchscreen display is the ability to receive input without requiring the presence of a dedicated input device. As consumer electronic devices (particularly mobile handsets) continue to reduce in size, the inclusion of a touchscreen provides a manufacturer the ability to further reduce the size of the device by eliminating the space required for an input terminal. In addition, by devoting the entirety of a device's surface area for use as a display rather than apportioning the surface area between a display area and an input terminal (e.g., keypad), the total display area may be increased, resulting in a superior user experience.

However, in general, mobile computing devices such as cell phones, smart phones and PDAs which use touchscreens as a primary method of input may be difficult or inconvenient to use. For example, typical touchscreens lack the tactile feedback provided by pressing a tangible button or key in a physical input terminal. Accordingly, users may be uncertain whether any key was actuated at all or any key was actuated more times than intended. Thus, in order for the user to be assured that input is being received as intended, the user is required to monitor the output field on the display to verify both that a key was entered, and more specifically, that the correct key was entered as intended.

Since data entry into the conventional touchscreen is simply based on the 2-D virtual keypad displayed on the monitor, the virtual keys are without depth or any feel other than the simple pressure reaction by the flat surface, and the user must therefore carefully aim to touch the desired virtual key. Unlike the conventional remote keyboard, the touchscreeen has no capability to provide tactile feedback to the user, which limits its usefulness and accuracy in use. Accordingly, it is desired to provide tactile feedback in a touch screen for matching the benefits of a mechanical keyboard.

### SUMMARY OF THE INVENTION

In one embodiment of the present disclosure, a keyboard system for interfacing with a touchscreen includes: a plurality of contact members formed of electrically conducting material, each of the contact members having first and second sides; and a plurality of keys. Each key has an electrically conducting key-pad unit and a resilient member, where the resilient member is adapted to maintain the key-pad unit in a spaced part relationship relative to the corresponding contact member. The first side of each contact member is in constant contact with a particular portion of the touchscreen. The key-pad unit is adapted to contact the second side of the corresponding contact member when pressed by a foreign object, to thereby form an electrically conducting path between the foreign object and the particular portion of the touchscreen thorough the contact members and the electrically conducting key-pad unit.

In another embodiment of the present disclosure, an electronic device includes a touchscreen and a keyboard system to be mounted on the touchscreeen. The keyboard system includes: a plurality of contact members formed of electrically conducting material, each of the contact members having first and second sides; and a plurality of keys. Each key has an electrically conducting key-pad unit and a resilient member, where the resilient member is adapted to maintain the key-pad unit in a spaced part relationship relative to a corresponding one of the contact members. The first side of each contact member is in constant contact with a particular portion of the touchscreen. The key-pad unit is adapted to contact the second side of a corresponding one of the contact members when pressed by a foreign object, to thereby form an electrically conducting path between the foreign object and the particular portion of the touchscreen thorough the contact members and the electrically conducting key-pad unit.

These and other features, aspects and advantages of the present invention will become better understood with reference to the following drawings, description and claims.

### BRIEF DESCRIPTION OF THE DRAWINGS

FIG. 1 shows an exploded view of a keyboard system disposed over a portion of a touchscreen in accordance with one embodiment of the present invention;

FIG. 2 shows a top view of a portion of the keyboard system of FIG. 1;

FIG. 3A shows a cross sectional view of the portion of the keyboard system in FIG. 2, taken along the line 3-3;

FIG. 3B shows a cross sectional view of the portion of the keyboard system in FIG. 2, illustrating the key action when a finger presses the key;

FIG. 4A shows a top view of a contact member in accordance with another embodiment of the present invention;

FIG. 4B shows a bottom view of the contact member of FIG. 4A;

FIG. 4C shows a bottom perspective view of the contact member of FIG. 4A;

FIG. 4D shows a side view of the contact member of FIG. 4A;

FIG. 4E shows a front view of the contact member of FIG. 4A;

FIG. 5 shows a cross sectional view of a portion of a keyboard system having the contact member of FIG. 4A;

FIG. 6 shows a top view of a portion of a keyboard system in accordance with yet another embodiment of the present invention;

FIG. 7 shows a cross sectional view of the portion of the keyboard system in FIG. 6, taken along the line 7-7; and

FIG. 8 shows a cross sectional view of a portion of a keyboard system in accordance with still another embodiment of the present invention;

FIG. 9A shows a top view of a portion of a keyboard system in accordance with further another embodiment of the present invention;

FIG. 9B shows a cross sectional view of the portion of the keyboard system of FIG. 9A, taken along the line 9-9;

FIG. 10 shows a cross sectional view of a portion of a keyboard system in accordance with yet further another embodiment of the present invention;

FIG. 11 shows a cross sectional view of a portion of a keyboard system in accordance with another embodiment of the present invention;

FIG. 12A shows a side view of a keyboard system rotatably attached to an electronic device or device case in accordance with still further another embodiment of the present invention;

FIG. 12B shows a side view of the keyboard system of FIG. 12A disposed over the touchscreen of the electronic device when being used;

FIG. 12C shows a side view of the keyboard system of FIG. 12A retracted under the electronic device when not used;

FIG. 13A shows a perspective view of a keyboard system slidably mounted to an electronic device in accordance with another embodiment of the present invention;

FIG. 13B shows a front view of the keyboard system of FIG. 13A disposed over the touchscreen of the electronic device when being used;

FIG. 13C shows a front view of the keyboard system of FIG. 13A stowed under the electronic device when not used; and

FIG. 14 shows a front view of a keyboard system slidably mounted to an electronic device in accordance with another embodiment of the present invention.

### DETAILED DESCRIPTION OF THE INVENTION

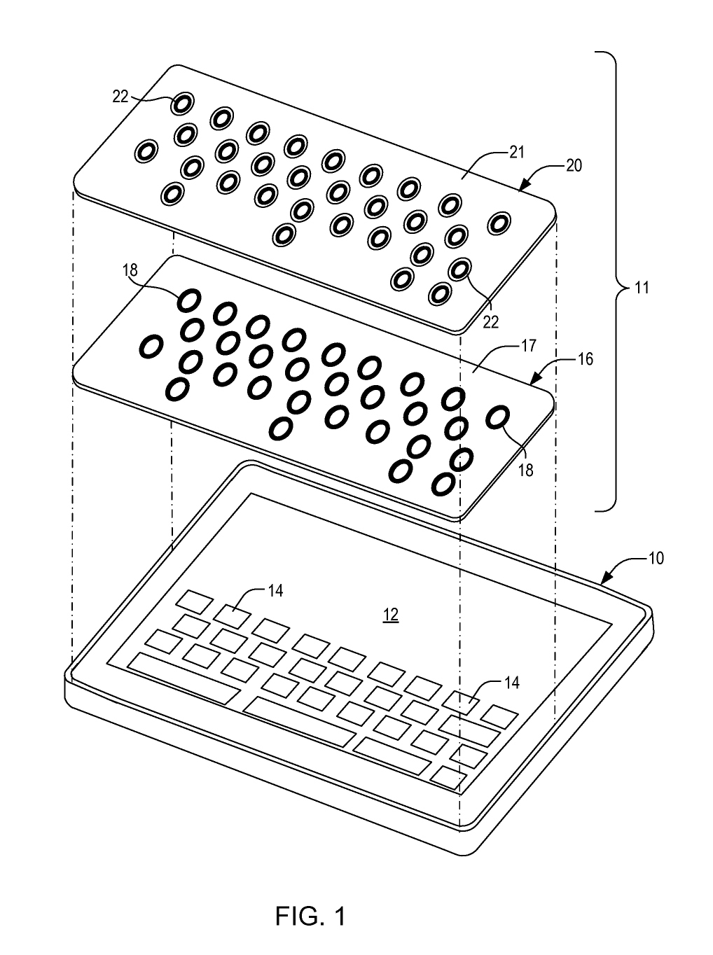

Referring now to FIG. 1, there is shown an exploded view of a keyboard system 11 to be disposed over a portion of a touchscreen 12 in accordance with one embodiment of the present invention. As depicted, a device 10 may be a conventional electronic device and includes the touchscreen 12 for displaying various digital images. The touchscreen 12 includes touch-sensitive sensors (not shown in FIG. 1) embedded therein, where the sensor implementation includes capacitive sensing technology. For the purpose of illustration, the sensors in the touchscreen 12 are considered to be capacitive sensors, even though other suitable type of sensors may be used in the touchscreen 12.

The touch-sensitive sensors are responsive to a physical stimulus or contact with a foreign object, such as finger or stylus. Thus, when an image including virtual keys 14 is displayed on the touchscreen 12, the user may input data to the device 10 by directly touching the virtual keys 14. Since the virtual keys 14 are displayed on 2-D touchscreen, the virtual keys 14 do not have depth or any feel other than the simple pressure reaction atop the flat touchscreen 12. Thus, the user may mount the keyboard system 11 on the touchscreen 12 so that the user can get tactile feedback when inputting data into the device 10.

The keyboard system 11 includes: a lower keyboard unit 16 having a lower panel 17 and a plurality of contact members 18 mounted in the lower panel 17; and an upper keyboard unit 20 having an upper panel 21 and a plurality of keys 22. When the keyboard system 11 is mounted on the touchscreen 12, the lower keyboard unit 16 makes a firm contact with the touchsreen surface. The lower panel 17 is formed of electrically insulating (or, equivalently, dielectric) material, such as rubber or plastic. The width and length of the lower panel 17 may be determined such that the lower keyboard unit 16 covers the entire image of the virtual keys 14. The contact members 18 are formed of electrically conducting material, such as metal, carbon-filled rubber, carbon-filled polymer, metal-filled rubber, metal-filled polymer. Each of the contact members 18 has a substantially circular ring shape and is disposed over the corresponding virtual key when the lower keyboard unit 16 is mounted over the touchscreen 12. The location and diameter of each contact member 18 are determined such that the character (or symbol) of the corresponding virtual key can be visible to the user through the inner hole of the contact member.

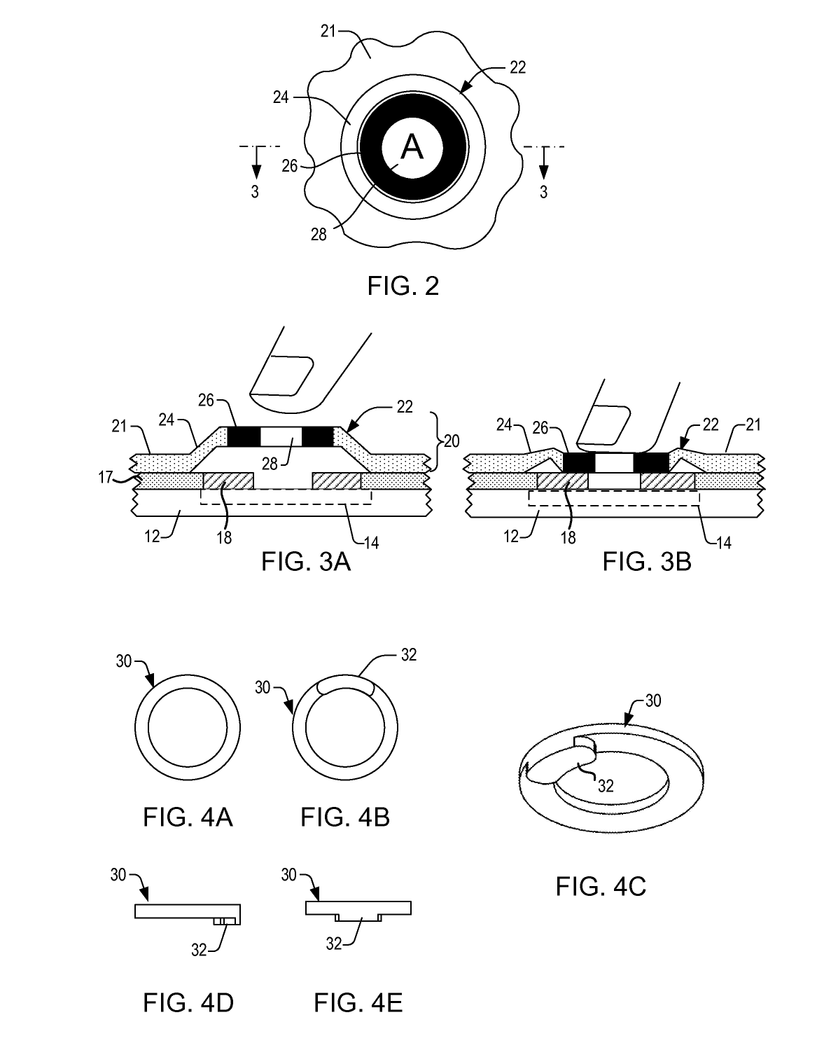

FIG. 2 shows a top view of a portion of the keyboard system 11. FIG. 3A shows a cross section view of the portion of the keyboard system in FIG. 2, taken along the line 3-3. As depicted, the lower panel 17 and contact members 18 are in firm contact with the touchscreen 12 when the keyboard system 11 is mounted on the touchscreen 12. The upper panel 21 of the upper keyboard unit 20 is in contact with the lower panel 17. The key 22 includes: a dome 24 (or, equivalently, spring member or resilient member); a key-pad ring 26; and a key-pad disk 28 secured to the key-pad ring 26. (A term key-pad unit collectively refers to the key-pad ring and key-pad disk.) The upper panel 21 may be formed of electrically insulating (or, equivalently, dielectric) material, such as silicone rubber or other elastomer. The dome 24 may be formed of a dielectric elastic material, such as silicone rubber or other elastomer, and configured to separate the key-pad ring 26 from the contact member 18 when the key-pad disk 28 is not pressed by a finger.

The key-pad ring 26 is formed of an electrically conducting material, such as metal, carbon-filled rubber, carbon-filled polymer, metal-filled rubber, metal-filled polymer. The key-pad disk 28 may be formed of a transparent material, such as polycarbonate or acrylic. The upper keyboard unit 20 is arranged relative to the lower keyboard unit 16 such that the user may see the character (or symbol, say “A”) displayed on the corresponding virtual key 14 through the transparent key-pad disk 28 and the inner hole of the contact member 18.

FIG. 3B shows a cross section view of the portion of the keyboard system in FIG. 2, illustrating the key action when a finger presses the key 22. When the user presses the key 22, more specifically the key-pad disk 28, the dome 24 flexes and bends to make a contact between the key-pad ring 26 and the contact member 18. Since the dome 24 is formed of elastic material, the deformed dome generates a resilient force so that the key 22 restores to its original position (as shown in FIG. 3A) when the user releases the key 22.

When the finger presses the key 22, the key-pad ring 26 makes a physical contact with the contact member 18. Thus, even though the virtual key 14 of the touchscreeen 12 is not directly activated by a user finger, the virtual key 14 is activated by bringing the indirect contact between the finger and the virtual key 14 via the key-pad ring 26, and the contact member 18. More specifically, the capacitance of the finger is transmitted to the virtual key 14 via the key-pad ring 26, and the contact member 18. Thus, key-pad ring 26 and the contact member 18 form an electrical path between the finger and virtual key 14.

While the touchscreen contact is the same as if a user had directly placed his or her finger on the touchscreen 12, the sensation to the user has been altered since the user can now feel the sensation of physical displacement of the key-pad disk 28 as well as the key-pad displacement arrested by contact with the contact member 18. Thus, the user receives a tactile feedback signal, while the signal has been applied to the touchscreen 12. The keyboard system 11 is a mechanical interface for the touchscreen 12 and provides tactile feedback to the user. The key-pad disk 28 may be eliminated depending on the design implementation.

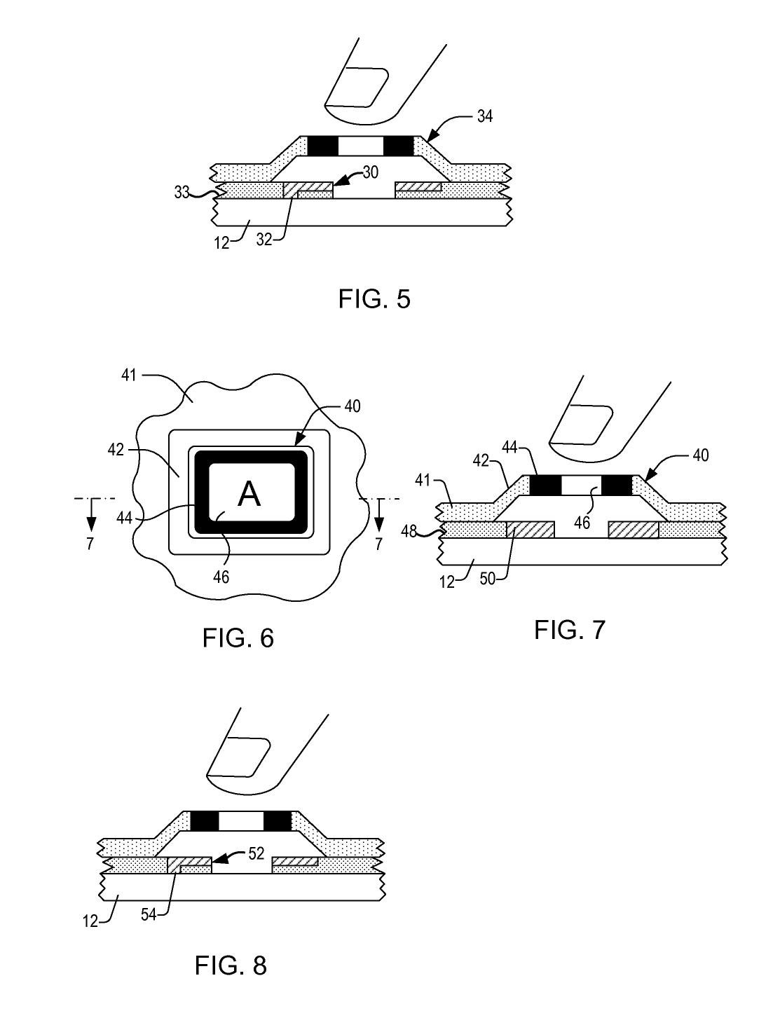

As shown in FIGS. 3A and 3B, the entire bottom surface of the contact member 18 contacts the corresponding virtual key 14. As an alternative, the actual contact area between the contact member 18 and the virtual key 14 may be modified so that the contact can more closely simulate a finger touch. FIGS. 4A-4E respectively show a top view, a bottom view, a side view, a front view, and a bottom perspective view of a contact member 30 in accordance with another embodiment of the present invention. As depicted, the contact member 30 includes a protrusion (or bump) 32 that makes a direct and constant contact with the corresponding virtual key 14. FIG. 5 shows a cross section view of a portion of a keyboard system having the contact member 30. As depicted, the keyboard system is similar to the system 11 (shown in FIG. 1) with the difference that the contact member 32 has a protrusion. The modification of the contact area of the contact member serves to produce an input more closely representing the touch of a finger, which the device is designed to recognize. This eliminates erroneous multi-activations. The bottom surface of the protrusion 32 may be flush with the bottom surface of lower panel 33, or may extend beyond the bottom surface of lower panel 33 to ensure a good contact with the virtual key 14.

The key 22 may have other geometrical shapes. FIG. 6 shows a top view of a portion of a keyboard system in accordance with yet another embodiment of the present invention. FIG. 7 shows a cross sectional view of the portion of the keyboard system in FIG. 6, taken along the line 7-7. As depicted, the keyboard system of FIG. 6 is similar to that of FIG. 2, with the difference that the key 40 has a substantially rectangular shape. The keyboard system includes: an upper panel 41; a dome 42 (or, equivalently, resilient or spring member); a key-pad ring 44 that has a substantially rectangular ring shape; a transparent key-pad disk 46 secured to the key-pad ring 44; a lower panel 48; and a contact member 50 that has a substantially rectangular ring shape. Since each of the components of the keyboard system shown in FIG. 6 is similar to its counterpart of the keyboard system 11 in FIGS. 1, 2, and 3A, the description of the keyboard system in FIGS. 6-7 is not repeated.

FIG. 8 shows a cross section view of a portion of a keyboard system in accordance with still another embodiment of the present invention. As depicted, the keyboard system in FIG. 8 is similar to that of FIG. 7, with the difference that the contact member 52 has a protrusion (or equivalently, bump) 54. The function and structure of the protrusion is similar to those of the protrusion 32 (shown in FIGS. 4A-4E).

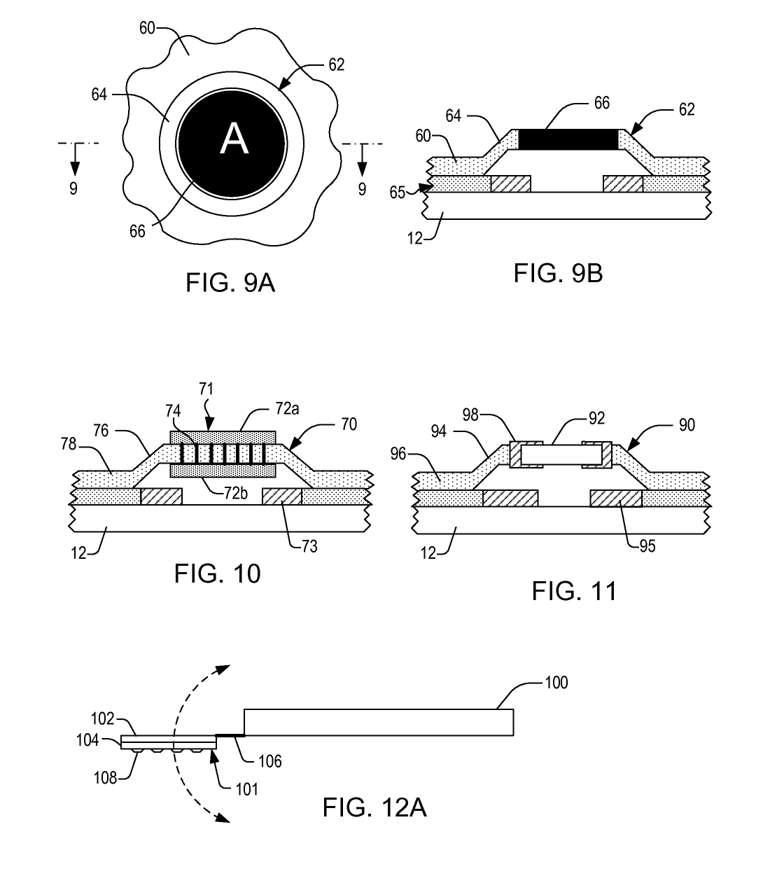

FIG. 9A shows a top view of a portion of a keyboard system in accordance with further another embodiment of the present invention. FIG. 9B shows a cross sectional view of the portion of the keyboard system of FIG. 9A. As depicted, the upper keyboard unit includes an upper panel 60 and a key 62, where the key 62 includes a dome 64 (or, equivalently, resilient member or spring member) and a key-pad disk 66. The key-pad disk 66 is formed of opaque and electrically conducting material, such as metal, carbon-filled rubber, carbon-filled polymer, metal-filled rubber, metal-filled polymer. The key-pad disk 66 may include a character (say, “A”) that matches the corresponding virtual key displayed on the touchscreen 12. Since the lower keyboard unit 65 is similar to the lower keyboard unit 16, the description of the lower keyboard unit is not repeated for brevity.

It is noted the key-pad disk 66 may be formed of transparent and electrically conducting material, such as ITO (indium tin oxide). In this embodiment, the user may see the characters displayed on the touchscreen through the key-pad disks, and thus, the key-pad disk 66 may not include any character that matches the corresponding virtual key displayed on the touchscreen 12.

FIG. 10 shows a cross sectional view of a portion of a keyboard system in accordance with yet further another embodiment of the present invention. As depicted, the upper keyboard unit includes an upper panel 78 and a key 70, where the key 70 includes a dome 76 (or, equivalently, resilient member or spring member) and a key-pad unit 71 having a pair of key-pad disks 72a, 72b connected by vias 74. One of the key-pad disk 72a or 72b may be eliminated as long as vias 74 can make good contact with the finger or the contact member 73. The vias 74 are formed of electrically conducting material, such as metal, carbon-filled rubber, carbon-filled polymer, metal-filled rubber, metal-filled polymer, and pass through the upper panel 78.

The key-pad disks 72a, 72b are formed of electrically conducting material, such as metal, carbon-filled rubber, carbon-filled polymer, metal-filled rubber, metal-filled polymer. When a finger of the user presses the key-pad disk 72a to thereby bring the key-pad disk 72b into contact with the contact member 73, the capacitance of the finger is transmitted to the virtual key displayed on the touchscreen 12 through the upper key-pad disk 72a, the vias 74, the lower key-pad disk 72b, and the contact member 73. Since the lower keyboard unit is similar to the lower keyboard unit in FIG. 9B, the description of the lower keyboard unit is not repeated for brevity.

FIG. 11 shows a cross sectional view of a portion of a keyboard system in accordance with another embodiment of the present invention. As depicted, the upper keyboard unit includes an upper panel 96 and a key 90 where the key 90 includes a dome 94 (or, equivalently, resilient member or spring member), a key-pad disk 92, and a key-pad ring 98. The key-pad disk 92 is formed of transparent material, such as polycarbonate or acrylic. The key-pad disk 92 is affixed to the dome 94. The key-pad ring 98 is formed of a thin electrically conductive material, such as metal, carbon-filled rubber, carbon-filled polymer, metal-filled rubber, metal-filled polymer.

The key-pad ring 98 makes a contact with the contact member 95 when the key-pad disk 92 is pressed by a finger of the user. Upon contact, the capacitance of the finger is transmitted to the virtual key displayed on the touchscreen 12 via the key-pad ring 98 and the contact member 95. The key-pad ring 98 may be formed on the surface of the key-pad disk 92 by various methods. For example, the key-pad ring 98 may be deposited on the key-pad disk 92 by the conventional chemical vapor deposition technique, or any other suitable vapor deposition technique. In another example, the key-pad ring 98 may be coated or printed on the key-pad disk 92. Since the lower keyboard unit is similar to the lower keyboard unit in FIG. 9B, the description of the lower keyboard unit is not repeated for brevity.

In each of FIGS. 2-11, the dome and upper panel are shown to form one integral body. For example, the dome 24 and the upper panel 21 are made from one sheet of dielectric panel. However, the dome may be fabricated separately from the upper panel and affixed to the upper panel, i.e., the dome 24 may be fabricated with the key 22 and secured to the upper panel 21 subsequently.

It is noted that the contact members in FIGS. 9A-11 do not have protrusion (or bump). However, it should be apparent to those of ordinary skill that the contact member 32 (shown in FIGS. 4A-4E) may be used in place of the contact members shown in FIGS. 9A-11. It is also noted that the key-pad disks and key-pad rings shown in FIGS. 1-11 may have a suitable geometry, such as circle, rectangle, or polygon.

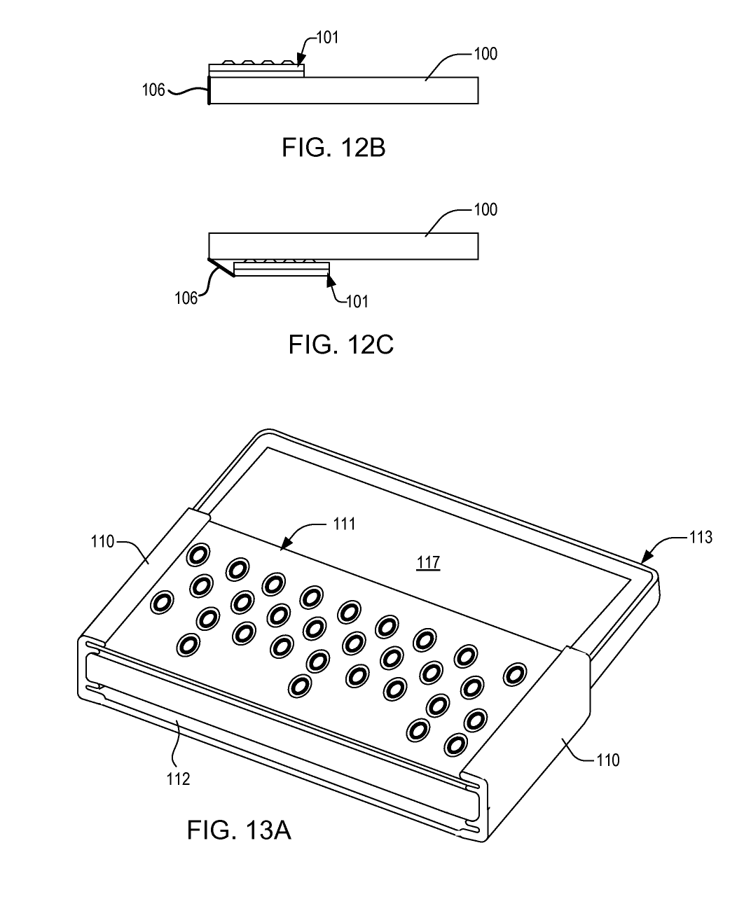

FIG. 12A shows a side view of a keyboard system 101 rotatably attached to an electronic device 100 or an electronic device case (not shown in the figure) by a linkage 106 in accordance with another embodiment of the present invention. As depicted, the keyboard system 101 includes an upper keyboard unit 104 and a lower keyboard unit 102. One end of the linkage 106 is rotatably attached to the electronic device 100 or an electronic device case (not shown in the figure) while the other end of the linkage 106 is rotatably attached to the keyboard system 101.

FIG. 12B shows a side view of the keyboard system 101, where the keyboard is disposed over the touchscreen of the electronic device 100. The user can interact with the device 100 by pressing the keys 108 in the keyboard system 101. FIG. 12C shows a side view of the keyboard system 101, where the keyboard system 101 is retracted under the electronic device or an electronic device case (not shown in the figure) when the user does not use the keyboard system 101.

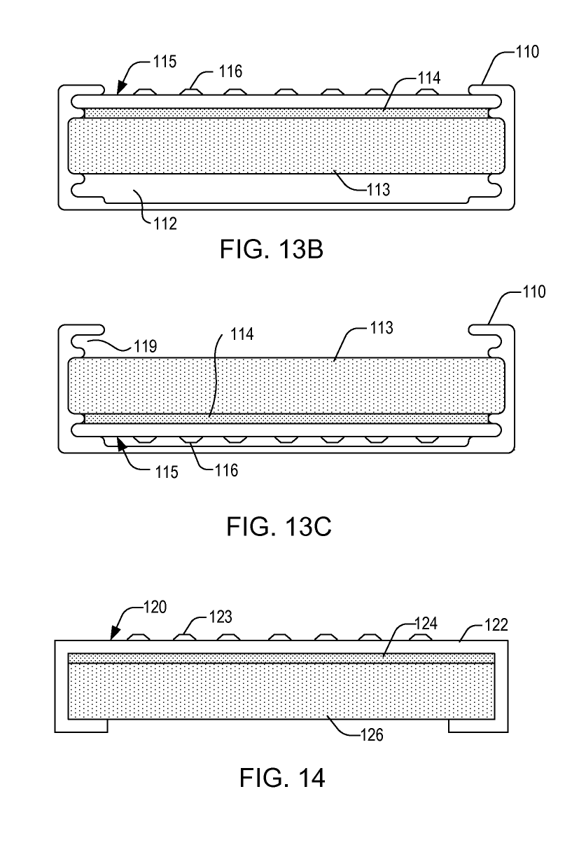

FIG. 13A shows a perspective view of a keyboard system 111 slidably mounted to an electronic device 113 in accordance with another embodiment of the present invention. FIG. 13B shows a front view of the keyboard system 111 disposed over the touchscreen 117 of the electronic device 113 when being used. FIG. 13C shows a front view of the keyboard system 111 stored in a cavity 112 when not used. As depicted, the keyboard system 111 includes: an upper keyboard unit 115 having keys 116; and a lower keyboard unit 114. The structures and functions of the upper and lower keyboard units 115, 114 are similar to those of the upper and lower keyboard units 20, 16, respectively, and thus the description of the units are not repeated.

The upper keyboard unit 115 and the lower keyboard unit 114 can be slidably mounted along the grooves 119 formed on the inner wall of a case 110 so that the user can use the keyboard system 111 to interact with the electronic device 113. The case 110 may be formed of material, such as plastic, that can provide mechanical strength to hold the keyboard system 111. The case 110 includes a cavity 112 where the keyboard system 111 can be stored when not used, as depicted in FIG. 13C.

FIG. 14 shows a front view of a keyboard system 120 slidably mounted to an electronic device 126 in accordance with another embodiment of the present invention. As depicted, the keyboard system 120 includes: an upper keyboard unit 122 having keys 123; and a lower keyboard unit 124. The structures and functions of the upper and lower keyboard units 122, 124 are similar to those of the upper and lower keyboard units 20, 16, respectively, and thus the description of the units are not repeated.

The upper keyboard unit 122 includes a panel that extends over the side of the electronic device 126 and covers a portion of the bottom surface of the electronic device so that the keyboard system 120 can be slidably mounted over the touchscreen of the electronic device 126. The keyboard system 120 can be slidably mounted under the electronic device 126 when the keyboard system 120 is not used.

It should be understood, of course, that the foregoing relates to exemplary embodiments of the invention and that modifications may be made without departing from the spirit and scope of the invention as set forth in the following claims.

What is claimed is:

1. A keyboard system for interfacing with a touchscreen, comprising:
a plurality of contact members formed of an electrically conducting material, each said contact member having first and second sides; and
a plurality of keys, each said key having an electrically conducting key-pad unit and a resilient member, said resilient member being adapted to maintain the key-pad unit in a spaced part relationship relative to a corresponding one of said plurality of contact members;
wherein the first side of each said contact member is in constant contact with a particular portion of the touchscreen; and
wherein the key-pad unit is adapted to contact the second side of a corresponding one of said plurality of contact members when pressed by a foreign object, to thereby form an electrically conducting path between the foreign object and the particular portion of the touchscreen.

2. A keyboard system as recited in claim 1, wherein the key-pad unit includes at least one of a key-pad disk and a key-pad ring formed of an electrically conducting material.

3. A keyboard system as recited in claim 2, wherein the key-pad disk has a substantially circular, oval, or polygon shape.

4. A keyboard system as recited in claim 2, wherein the key-pad ring has a substantially circular, oval, or polygon shape.

5. A keyboard system as recited in claim 2, wherein the key-pad ring is formed on a portion of a top surface of the key-pad disk, a portion of a bottom surface of the key-pad disk, and a portion of a side of the key-pad disk.

6. A keyboard system as recited in claim 1, wherein the key-pad unit includes one or more key-pad disks connected to one or more vias, the key-pad disks and the vias are formed of an electrically conducting material.

7. A keyboard system as recited in claim 1, wherein each said contact member includes a bump formed on the first side and in constant contact with the particular portion of the touchscreen.

8. A keyboard system as recited in claim 1, further comprising:
a first panel formed of a dielectric material,
wherein the plurality of contact members are secured to the first panel.

9. A keyboard system as recited in claim 8, further comprising:
a second panel formed of a dielectric material,
wherein the plurality of keys are secured to the second panel.

10. A keyboard system as recited in claim 1, wherein the keyboard system is slidably mounted to a touchscreen.

11. A keyboard system as recited in claim 1, wherein the keyboard system is rotatably mounted to a touchscreen.

12. A keyboard system as recited in claim 1, wherein the key-pad unit includes a key-pad disk formed of a transparent material so that a user is able to see the particular portion of the touchscreen therethrough.

13. An electronic device, comprising:
a touchscreen;
a keyboard system for interfacing with the touchscreen, said keyboard system including:
a plurality of contact members formed of an electrically conducting material and having first and second sides; and
a plurality of keys, each said key having an electrically conducting key-pad unit and a resilient member, said resilient member being adapted to maintain the key-pad unit in a spaced part relationship relative to a corresponding one of said plurality of contact members;
wherein the first side of each said contact member is in constant contact with a particular portion of the touchscreen; and
wherein the key-pad unit is adapted to contact the second side of a corresponding one of said plurality of contact members when pressed by a foreign object, to thereby form an electrically conducting path between the foreign object and the particular portion of the touchscreen.

14. An electronic device as recited in claim 13, wherein the key-pad unit includes at least one of a key-pad disk and a key-pad ring formed of an electrically conducting material.

15. An electronic device as recited in claim 13, wherein the key-pad unit includes one or more key-pad disks connected to one or more vias, the key-pad disks and the vias are formed of an electrically conducting material.

16. An electronic device as recited in claim 13, wherein each said contact member includes a bump formed on the first side and in constant contact with the particular portion of the touchscreen.

17. An electronic device as recited in claim 13, further comprising:
a first panel formed of a dielectric material,
wherein the plurality of contact members are secured to the first panel.

18. An electronic device as recited in claim 17, further comprising:
a second panel formed of a dielectric material,
wherein the plurality of keys are secured to the second panel.

19. An electronic device as recited in claim 13, wherein the keyboard system is rotatably mounted to a touchscreen.

20. An electronic device as recited in claim 13, wherein the key-pad unit includes a key-pad disk formed of a transparent material so that a user is able to see the particular portion of the touchscreen therethrough.
